(19) United States
(12) Patent Application Publication
(10) Pub. No.: US 2004/0186883 A1
(43) Pub. Date: Sep. 23, 2004

(54) Method and apparatus for interfacing web services with mobile terminal applications during a browser or SIP session

(76) Inventors: Kai T. Nyman, Espoo (FI); Mikko Olkkonen, Kirkkonummii (FI); Suresh Chande, Vantaa (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/392,275

(22) Filed: Mar. 19, 2003

(51) Int. Cl. G06F 17/60

(52) U.S. Cl. 709/203

(57) ABSTRACT

A method and corresponding equipment implementing a protocol stack (40s 40t-s 40t-t) with which an application hosted by a Web server connected to the Internet or hosted by a wireless terminal communicates with an application hosted by a wireless terminal, and conversely. The protocol stack (40s 40t-s 40t-t) includes an application layer protocol handler (43) that uses the services of an HTTP transport layer (45) for terminal-to-terminal and server-terminal communications, and also uses the services of a SIP transport layer (47) for terminal-to-terminal and server-to-terminal communications.

### TECHNICAL FIELD

The present invention relates to accessing the World Wide Web using a mobile terminal or other wireless communication device, and more particularly to an application layer communication protocol for use where one communicating party is an application in a mobile terminal or other wireless communication device, and another communicating party (of two or more communicating parties) is a server application or an application in another mobile terminal or other wireless communication device.

### BACKGROUND ART

Modern cell phones (mobile terminals) often include LED displays and a corresponding user interface similar in some respects to what is provided with typical personal computers. Just as personal computers today often connect to the World Wide Web (WWW) of the Internet in order to access services provided over the Web by applications hosted by servers connected to the Web, so too do many modern cell phones. Indeed, modern cell phones often provide a browser similar in functionality to the browsers used by personal computers for interfacing with applications on servers connected to the Web.

An application is here called a Web service if it has a protocol interface defined using an extensible markup language (XML) document. Such Web services are known in the art. It is also known that Web service transactions can use a multitude of different protocols. Known protocol bindings include binding to HTTP (hypertext transfer protocol) and different messaging protocols. Web services according to the prior art often use a particular application layer protocol, namely the so-called simple object access protocol (SOAP).

A server, as used here, is a device that is connected to the Internet, and has an Internet Internet Protocol (IP) address and a Domain Name Space (DNS) name.

A (wireless) terminal, as used here, is a device that does not usually have a permanent IP address or DNS name. A terminal can connect to a server through the so called Network Address Translation functions. Communication from the terminal to the server is possible only if the terminal connects itself to the server; communication in the opposite direction is possible only after the terminal has initiated the connection to the server.

The prior art teaches end-to-end connectivity using a protocol stack for (interoperability) between applications connected to the Web via wireline, but does not teach end-to-end connectivity for applications hosted by a (wireless) terminal. Moreover, the prior art also teaches the usage of Multipurpose Internet Mail Extension (MIME) types (enclosures to e-mail) to invoke through a browser on a terminal the applications hosted by the terminal, and also teaches using the so-called session description protocol (SDP) in conjunction with communication sessions, created using SIP (session initiation protocol), between a terminal and an application on the Web. However, the prior art does not teach: how to use a SIP session invitation from a server to invoke a certain Web service application on a terminal; how to use the established SIP session as a bearer for Web service transactions; or how to use a MIME format in a browser to invoke a Web service handler in a terminal (i.e. during a browsing session).

The prior art enables an application hosted by a (wireless) terminal (e.g. a mobile phone) to initiate a connection to a Web service application on a server or a connection to a Web service application on another terminal. In addition, according to the prior art, a server application can connect to a Web service application on a terminal. A server application needing to contact a terminal-hosted Web application needs to use either some messaging transport or a SIP session. Since terminals do not usually have an IP address or a DNS name, it is impossible for a server to contact a terminal without the help of some messaging transport mechanism or some session initiation mechanism. Using a messaging transport mechanism is known in the art, but the art does not teach using an SIP session as a bearer for a Web service. Also, the prior art does not teach any mechanism by which, after a terminal browser contacts an application on a server (i.e. a terminal-hosted Web service), the server application can request information from the terminal-hosted application during the browsing session.

### DISCLOSURE OF THE INVENTION

Accordingly, in a first aspect of the invention, a method is provided by which an invoking application hosted by a Web server connected to the Internet or hosted by a wireless terminal invokes a target application hosted by a wireless terminal, the method for use after either an IP session initiated using SIP signalling or a browser session is established between the host of the invoking application and the host of the target application, the method comprising: a step in which an application layer protocol handler on the host of the invoking application creates an XML-based message encapsulating it in an XML-based application protocol header constructed so as to identify the target application, and sends the XML-based message to the host of the target application; a step in which the host of the target application, upon receiving the XML-based message, detects from the header that the XML-based message is to be forwarded to a target-side application layer protocol handler also hosted by the host of the target application; and a step in which the target-side application layer protocol handler, upon receiving the encapsulated XML-based message, determines the target application to be invoked based on the header, extracts the XML-based message, invokes the target application, and passes the XML-based message to the target application.

In accord with the first aspect of the invention, in case of an IP session initiated using SIP signalling, an SIP client on the host of the target application, upon receiving the XML-based message provided as part of a SIP header-bearing SIP message, may detect from a SDP identifier included in the SIP header that the XML-based message is to be forwarded to the target-side application layer protocol handler also hosted by the host of the target application and the application layer protocol handler in turn determines the target application based on a globally agreed-on identifier. Further, the globally agreed-on identifier may be included in the XML-based application protocol header and may be a URL (uniform resource locator) or a URN (uniform resource name) or a UUID (universal unique identifier). Also further, the XML-based application protocol header may be a SOAP header.

Also in accord with the first aspect of the invention, in case of a browser session between the host of the target application and the host of the invoking application, the XML-based message may be a SOAP message having a SOAP header and embedded as a MIME enclosure of a predetermined type in an XHTML or WML message, and the type of the MIME enclosure may indicate that the MIME enclosure is to be provided to the target-side application layer protocol handler, and the SOAP message header may identify the target application. Further, the SOAP message may also have a SOAP body, and the SOAP message body may provide a remote procedure call for the target application. Also further, to indicate the target application, a URL or a URN or a UUID may be used.

Also in accord with the first aspect of the invention, the XML-based message may be provided to the target application based either on a remote procedure call or on a simple message exchange mechanism.

Also in accord with the first aspect of the invention, the XML-based message may be accompanied by a message for display to a user by the host of the target application.

Also in accord with the first aspect of the invention, the underlying transport mechanism for the XML-based message may be either SIP or HTTP.

In a second aspect of the invention, a terminal is provided comprising means for performing the steps performed according to the first aspect of the invention in respect to the host of the target application and also in respect to the host of the invoking application.

In a third aspect of the invention, a server is provided comprising means for performing the steps performed according to the first aspect of the invention in respect to the host of the invoking application in case the host of the invoking application is the Web server connected to the Internet.

In a fourth aspect of the invention, a system is provided, comprising a terminal and a server, the terminal and the server comprising means for performing the steps performed according to the first aspect of the invention in respect to the host of the target application and the host of the invoking application, respectively.

In a fifth aspect of the invention, an apparatus is provided implementing a protocol stack by which an application hosted by a wireless terminal communicates with an application on a second device that is either a Web server connected to the Internet or another wireless terminal, the protocol stack comprising: a routing layer, for providing connectivity between the terminal and the second entity; a transport layer, interfacing with the routing layer for providing transport services and including at least one transport layer protocol stack including a HTTP transport layer; an application layer protocol handler, interfacing with the transport layer and also interfacing with an application via communication tools so as to provide communication services to and from the application; at least one application; wherein in response to an XML-based message encapsulated in an XML-based application protocol header constructed so as to identify the at least one application, the application protocol layer handler invokes the at least one application according to the XML-based message.

In accord with the fifth aspect of the invention, the protocol stack may further comprise: in the transport layer, a second transport layer protocol stack including a SIP transport layer and a SDP transport layer.

In a sixth aspect of the invention, a method is provided by which an invoking application hosted by a Web server connected to the Internet or hosted by a wireless terminal invokes a target application hosted by a wireless terminal, the method comprising: a step in which either the host of the invoking application or the host of the target application initiates with the other an IP session using SIP signalling; a step in which an application layer protocol handler on the host of the invoking application creates an XML-based message encapsulating it in an XML-based application protocol header identifying the target application and sends the XML-based message to the host of the target application using a transport protocol suitable for communication via the IP session; a step in which an SIP client on the host of the target application, upon receiving the XML-based message, detects from a globally agreed-on identifier included in the header that the XML-based message is to be forwarded to a target-side application layer protocol handler also hosted by the host of the target application; and a step in which the target-side application layer protocol handler, upon receiving the encapsulated XML-based message, determines the target application to be invoked, extracts the XML-based message, invokes the target application, and passes the XML-based message to the target application.

In accord with the sixth aspect of the invention, the header may be a SOAP header.

Also in accord with the sixth aspect of the invention, the globally agreed-on identifier may be a SIP SDP identifier or a MIME identifier.

In a seventh aspect of the invention, a method is provided by which an invoking application hosted by a Web server connected to the Internet or hosted by a wireless terminal invokes a target application hosted by a wireless terminal, the method comprising: a step in which a browser on the host of the target application initiates a browser session with the host of the invoking application; a step in which an application layer protocol handler on the host of the invoking application creates an XML-based message encapsulating it in an XML-based application protocol header having a predetermined MIME format and sends the XML-based message to the host of the target application via the browser session; a step in which the host of the target application, upon receiving the XML-based message, determines from the MIME format of the header that the message is to be forwarded to a target-side application layer protocol handler also hosted by the host of the target application, and provides the message to the target-side application layer protocol handler; a step in which the target-side application layer protocol handler, upon receiving the encapsulated XML-based message, determines the target application to be invoked based on the header, extracts the XML-based message, invokes the target application, and passes the XML-based message to the target application.

In accord with the seventh aspect of the invention, the header may be according to SOAP.

In an eighth aspect of the invention, a computer program product is provided comprising: a computer readable storage structure embodying computer program code thereon for execution by a computer processor in a terminal hosting a target application and used for communicating with a Web server connected to the Internet or another terminal hosting an invoking application, said computer program code for use after either an IP session initiated using SIP signalling or a browser session is established between the host of the invoking application and the host of the target application and after an application layer protocol handler on the host of the invoking application creates an XML-based message encapsulating it in an XML-based application protocol header constructed so as to identify the target application, and sends the XML-based message to the host of the target application, said computer program code comprising: computer program code for causing the computer processor to perform a step in which the host of the target application, upon receiving the XML-based message, detects from the header that the XML-based message is to be forwarded to a target-side application layer protocol handler also hosted by the host of the target application; and computer program code for causing the computer processor to perform a step in which the target-side application layer protocol handler, upon receiving the encapsulated XML-based message, determines the target application to be invoked based on the header, extracts the XML-based message, invokes the target application, and passes the XML-based message to the target application.

In a ninth aspect of the invention, a computer program product is provided comprising: a computer readable storage structure embodying computer program code thereon for execution by a computer processor in a Web server connected to the Internet or terminal hosting an invoking application and communicating with a terminal hosting a target application, said computer program code for use after either an IP session initiated using SIP signalling or a browser session is established between the host of the invoking application and the host of the target application, said computer program code comprising: computer program code for causing the computer processor to perform a step in which an application layer protocol handler on the host of the invoking application creates an XML-based message encapsulating it in an XML-based application protocol header constructed so as to identify the target application; and computer program code for causing the computer processor to perform a step of sending the XML-based message to the host of the target application; wherein the XML-based message and its encapsulation are such as to make possible detection by the host of the target application that the XML-based message is intended for delivery to the target application.

The invention enables applications hosted by a cell phone (or other wireless terminal) to be identified by URL's (like in SOAP) instead of MIME and SDP types used by browsers and SIP protocol implementations, respectively. URL's are more flexible because URL's do not impose a cumbersome application policy, such as requiring that a new type MIME be applied for in case of each new application. The invention allows a new (unique) URL to be generated in case of a new application once there is a root URL owned by an organization (i.e. an operator network, for example).

Further, the invention allows an application external to a terminal (either hosted on a server or on another terminal) to communicate a message to an application hosted by the terminal without requiring any changes to the components of the terminal environment, using the services of a terminal application protocol framework according to the invention. The message may be provided to the terminal application protocol framework by the external application using either SIP or a browser session. The invention also provides a mechanism—a Remote Procedure Call or API Call or message-based exchange mechanism—for identifying the target terminal application so as to make possible delivery of the message to the intended application. According further to the invention, when a message is received from an external application, a software component of the terminal may process the message for one or more purposes, including authentication, authorization, checking for user acceptance.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram of a protocol stack for communication between a terminal and either another terminal or a server connected to the Internet, according to the invention and so including an application layer protocol handler;

FIG. 2 is a schematic illustration of an exchange of messages resulting in a target application on a terminal being invoked by an application on a Web server connected to the Internet, according to the invention;

FIG. 3A is a schematic illustration of a server application to terminal application and terminal application to terminal application protocol, according to the invention;

FIG. 3B is a schematic illustration of a terminal application to server application protocol, according to the invention;

FIG. 4A is a schematic illustration of a protocol stack for communication between an application on a server and an application on a terminal, according to the invention;

FIG. 4B is a schematic illustration of a protocol stack for communication between an application on a terminal and an application on another terminal, according to the invention;

FIGS. 5A and 5B show alternative mechanisms by which a target application on a terminal is invoked, according to the invention; and

FIG. 6 is a flowchart indicating steps of a method by which an application on a Web server connected to the Internet or a (wireless) terminal invokes a target application on another terminal, according to the invention.

### BEST MODE FOR CARRYING OUT THE INVENTION

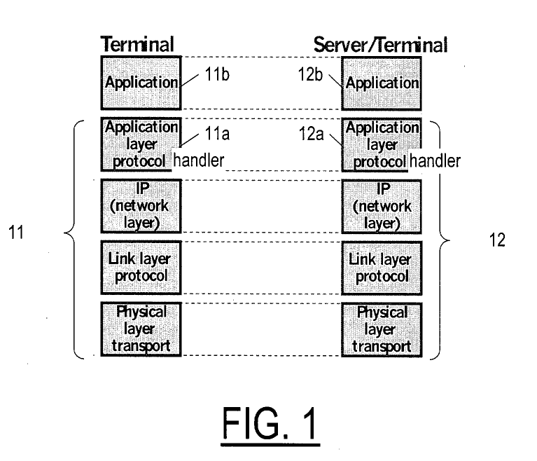

Referring now to FIG. 1, the invention provides a protocol stack 11 12 including an application layer protocol handler 11a 12a in both a sending entity and a receiving entity for enabling services (applications) 11b available on the (World Wide) Web to interface with services (applications) hosted by a wireless terminal 12b. In other words, the invention provides a set of protocols/protocol layers (i.e. a protocol layer stack) that can deliver messages to a terminal from a Web-connected server or other terminal. For example, the invention provides a protocol by which a ticket-vendor application hosted by a server connected to the Web can communicate with a wallet application hosted by a cell phone so that a user of the cell phone can pay the ticket-vendor application for a movie ticket using the wallet application and then receive a ticket (or proof of purchase of a ticket) over the same communication channel used by the browser, as opposed to over an alternative channel, i.e. e.g. via SMS (short message service).

To appreciate the utility of the invention, it is necessary to understand that a server on the Internet cannot initiate a connection to a (wireless) terminal without using SIP, SMS or some other messaging infrastructure. A terminal, even though it may have an IP address, is not usually visible on the Internet, not even in cases where the terminal has a PDP (packet data protocol) connection and the PDP connection is always on. A terminal does not have an ordinary Internet IP address but instead has a private domain IP address; it is not possible for a server on the Internet to send a message (over the Internet) to a device with a private IP address unless the device contacts the server or the server uses some other means besides ordinary (plain) IP connectivity to contact the terminal.

The invention addresses the problem of how SOAP (simple object access protocol) messages (or other XML-based messages) can be routed to a SOAP engine/WS (workstation) based application, specifically in the terminal environment, no matter which underlying transport mechanism (such as HTTP) is utilized. (SOAP is a lightweight protocol for exchange of information in a decentralized, distributed environment; it is an XML-based protocol that consists of three parts: an envelope that defines a framework for describing what is in a message and how to process it, a set of encoding rules for expressing instances of application-defined data types, and a convention for representing remote procedure calls and responses. See e.g. Simple Object Access Protocol (SOAP) 1.1, W3C (World Wide Web Consortium) Note; May 8, 2000. A SOAP message, as opposed to SOAP itself, is an XML document that consists of a mandatory SOAP envelope, an optional SOAP header, and a mandatory SOAP body.)

In case HTTP is used as the underlying transport mechanism, when a user uses a cell phone implementing the invention to access a Web page of a server using a browser hosted by the cell phone, a response by the user to the Web page in the form of a XHTML-page-based-form submission (XHTML indicating the extensible hypertext markup language, a reformulation of HTML 4 as an XML 1.0 application) could lead to the server sending a confirmation message to the phone display and at the same time a SOAP request/response message to be delivered to an application hosted by the terminal. (W3C has defined XHTML as the official Web markup standard, replacing HTML. XHTML is a hybrid between HTML and XML and is specifically designed for Net device displays. It is a markup language written in XML, and it is therefore an XML application. By offering a clean structure to Web pages across device types, XHTML is a key step toward the much needed integration of mobile Internet with the wired Internet.)

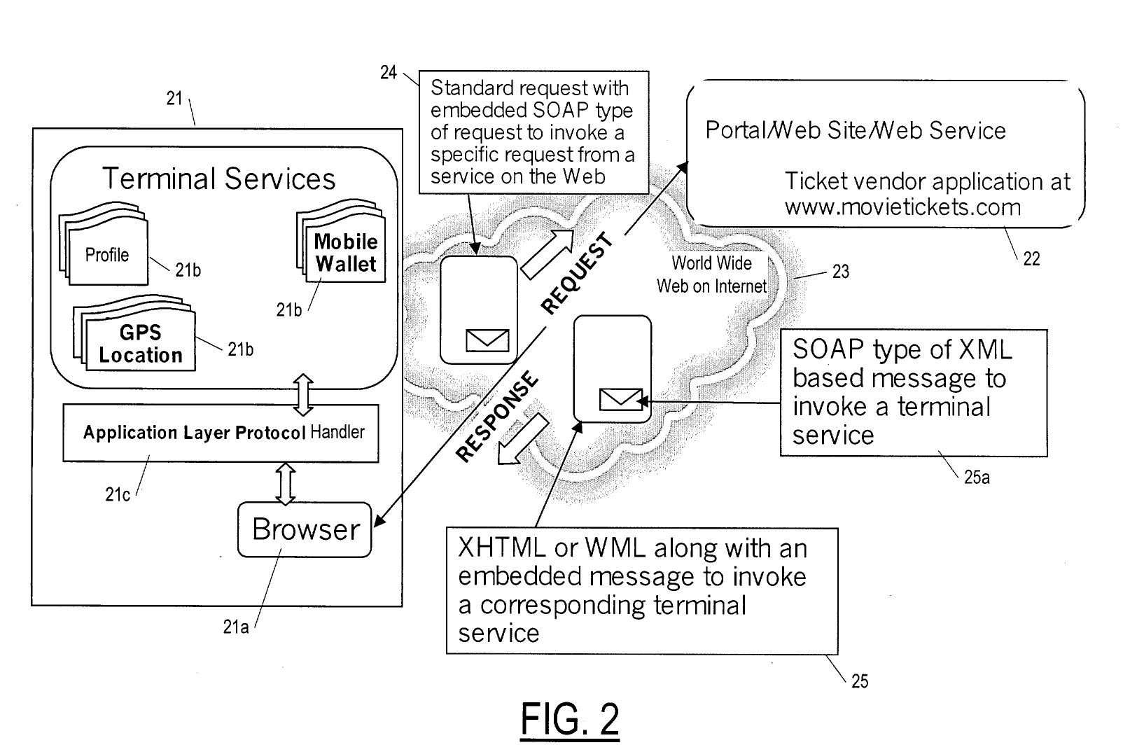

Referring now to FIG. 2, the invention is described here using a scenario in which a user purchases a ticket to a film using a (wireless) terminal. In the scenario, the user of the terminal 21 (e.g. a cellular phone) communicates with a ticket vendor Web application hosted by a server at a website 22 with the intention of purchasing a ticket for a film the use will select from a list of films provided by the ticket vendor application. The ticket vendor application interacts (exchange messages) with various applications 21b hosted by the terminal in order to sell the ticket to the user, including a GPS application (for location information), a wallet application (for payment and storage of confirmation of the ticket), and a profile application (for user preferences). (See FIG. 2.)

When the user interacts with the ticket vendor application over the Web indicating a desire to see a film and to have the ticket vendor application indicate what films are being shown at the location of the user, the vendor application determines user information, such as current location by interacting with the GPS application hosted by the terminal, language preference by interacting with the profile application hosted by the terminal, and then presents film choices to the user based on the user information acquired by the ticket vendor. The user then places an order with the ticket vendor application and indicates that the tickets are to be paid for using money in the electronic wallet application hosted by the terminal, i.e. a data store maintained by an application hosted by the terminal and indicating e.g. an account balance with the ticketing agency or some third party that will pay the ticketing agency for tickets purchased by the user. The ticket vendor application then communicates with the wallet application to determine if funds are available to pay for the ticket, and, if so, deducts the cost of the ticket, sends the gate an order to make the ticket available on demand, and send a confirmation (electronic receipt) to the user, which could be stored in the user electronic wallet (i.e. in a data store used by the wallet).

The user interaction with the ticket vendor application over the network can be established either when the user initiates a browser session with the ticket vendor application website, or when the user uses SIP to initiate an SIP session. The user sends messages to the ticket vendor application via a suitable user interface (visual and/or voice) with the messages included in documents according to XHTML (extended hypertext markup language), WML (wireless markup language), VXML (voice extensible markup language) or some other scripting language. In the other direction, the ticket vendor application communicates with the terminal applications using messages according to one or another XML-based application protocol (such as e.g. messages according to SOAP), and, at the same time, the ticket vendor application sends messages to the terminal applications, it can send related messages to the user via the user interface of the terminal (i.e. via e.g. the browser).

The ticket vendor application, on establishing end-to-end connectivity with a terminal application (via either SIP or a browser) prepares an application-specific XML-based message according to an XML-based application protocol (e.g. SOAP). Any such message has a header entry. The message created by the ticket vendor application contains a unique (terminal) application identifier as part of the XML-based header entry (such as, in the case as SOAP, a SOAP Header). On receiving the XML-based message, the application layer protocol handler (as seen in FIG. 1) checks for the application identifier, identifies the recipient application, and then delivers the message to the intended recipient (terminal application). The message delivery can be either based on a remote procedure call or a simple message exchange mechanism.

The application layer protocol handler handles application specific messages that arrive from an external application, be it from an external application hosted on a website or an application hosted by another terminal. It is responsible for the identification of the rightful terminal application to which a message is to be delivered and for ensuring delivery of the message. In case end-to-end connectivity is established using a browser session as opposed to an IP session initiated using SIP signalling, the browser needs to address all responses from the external application containing specific MIME class types to be delivered to the application layer protocol handler. The external applications could deliver Multi-Part content containing both content presentable to the user as well as messages intended solely for a terminal application.

As mentioned, even though in the above scenario the external application, i.e. the application not hosted by the user terminal, is hosted by a website, the invention also enables an application on another terminal to send messages to an application hosted by the user terminal.

It is important to understand that the prior art allows interoperability between a terminal application and a Web server application based only on so-called short messages—providing such services as ringtones, screen savers, and short message service (sms) text messaging—where the terminal software understands from a message header that it is to deliver the message to a particular terminal application. This has the disadvantage that the introduction of any new application specific messaging requires changing/upgrading terminal (cell phone) software, and in order to have the changes/upgrades made, the terminal user must typically visit a service center. In addition, there is no prior art solution allowing a message to be delivered to a third-party developed application; for example, in case of the MIDP (mobile information device profile) application called myMiniAlbum implemented on a terminal, including photos selected from the Club Nokia hosted service/application MyPhotoAlbum available over the Web, there is no means by which MyPhotoAlbum on the server is able to use SMS services to interact with MyMiniAlbum on the terminal, other than its own ad hoc protocol. The invention overcomes both disadvantages; new applications can be registered with the application layer protocol handier provided by the invention and this can be part of the service deployment or installation procedure, and any messages invoking an application hosted by the terminal and provided to the application layer protocol (by e.g. a browser hosted the wireless terminal or else by software for enabling a SIP session) will be delivered to the application, whether third-party developed or not. The invention provides a means to make this happen. The application layer protocol handler can receive and dispatch a general message to/from a terminal service from/to a Web server application, using XML-based messaging.

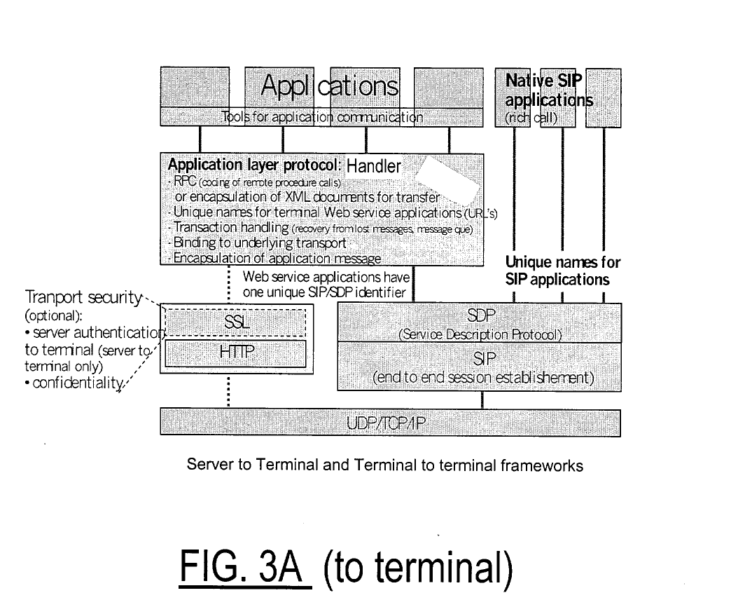

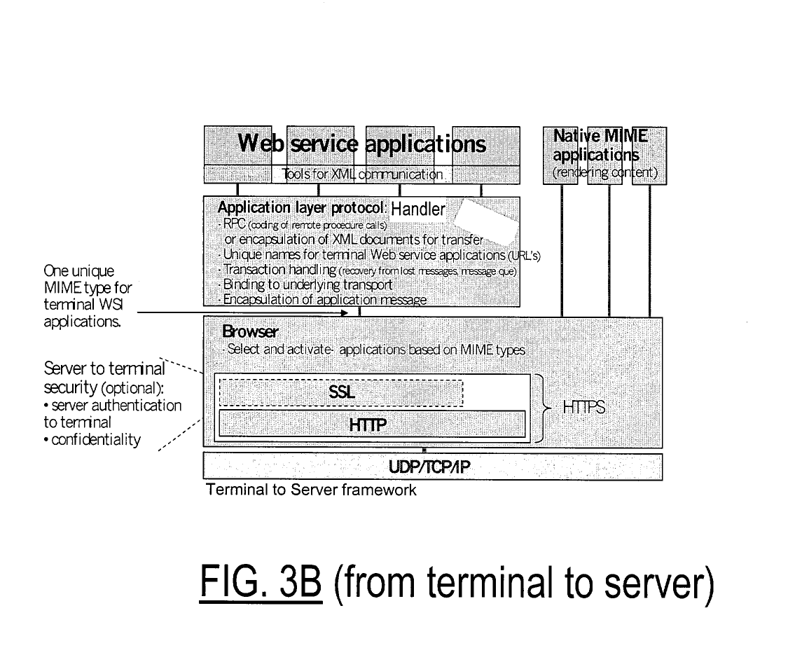

Referring now to FIGS. 3A and 3B, the protocol stack for wireless terminal application/Web server application interoperability, according to the invention, is shown in terms of functions of the application layer protocol handler and its interfaces with other layers of the protocol stack. FIG. 3A shows the stack for messages to an application hosted by a wireless terminal from either another wireless terminal or from a server, and so shows the protocol stack on the server or other terminal, and FIG. 3B shows the stack for messages from an application hosted by a terminal to a Web server application hosted by a server, and so shows the protocol stack on the terminal hosting the sending application.

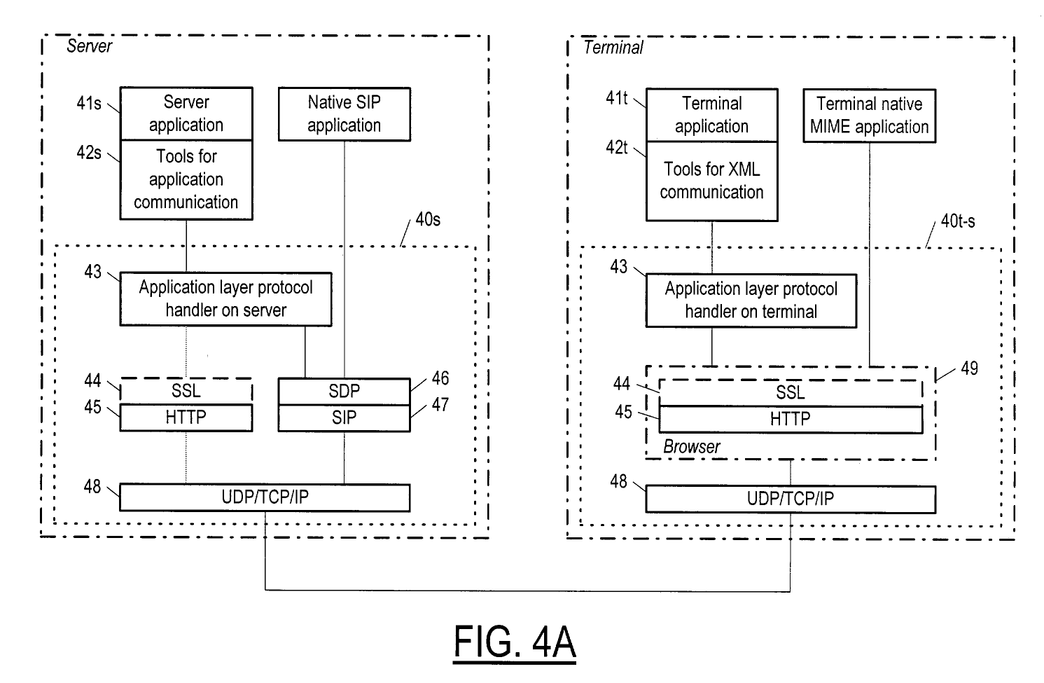

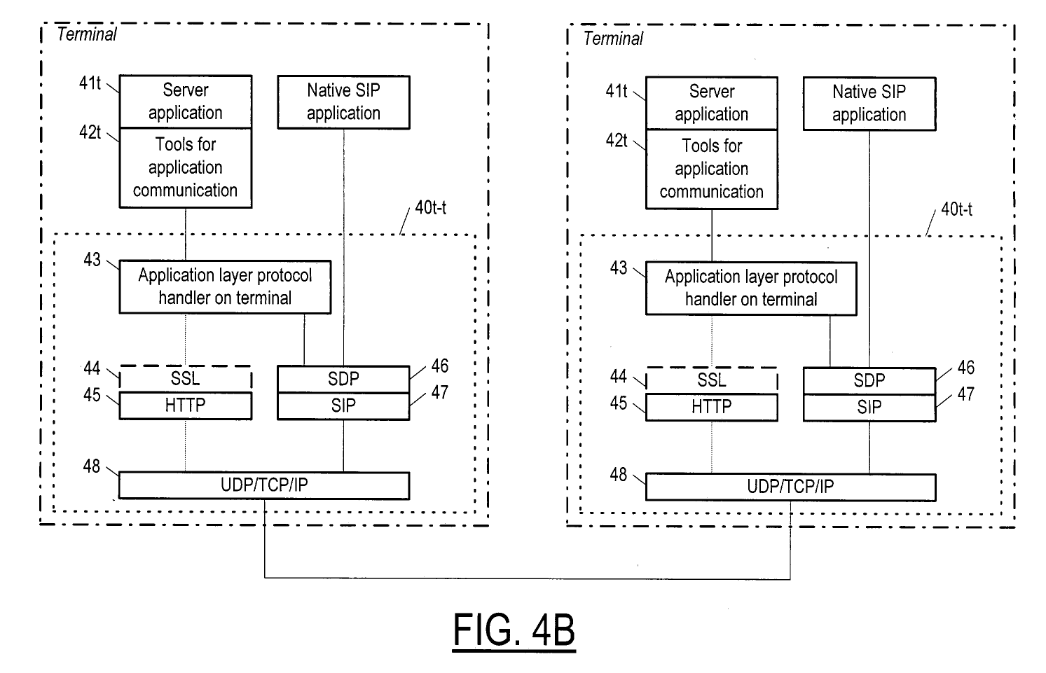

Referring now also to FIGS. 4A and 4B, the protocol stacks of FIGS. 3A and 3B are shown in the two possible couplings to which the invention applies: terminal-terminal and server-terminal. FIG. 4A shows server-terminal communications using the protocol stack of the invention, and FIG. 4B shows terminal-terminal communications using the protocol stack of the invention. As shown in FIG. 4A, according to the invention a server application 41s communicates with a terminal application 41t via a server protocol stack 40s and a terminal protocol stack protocol 40t-s, each protocol stack including the application layer protocol handler 43 of the invention, a UDP/TCP/IP (routing) layer 48, and a transport layer including a transport layer protocol stack including a HTTP (transport) layer 45 and an optional SSL (transport) layer 44, with the transport layer protocol stack implemented as a component of a browser 111. On the server, the protocol stack 40s also includes a second transport layer protocol stack including an SIP protocol layer 47 and an SDP protocol layer 46. The application layer protocol handler 43 on the server communicates with the server application 41s via a communication tools sublayer of the application layer, and the terminal side includes a corresponding tools sublayer 42t. Thus, the application layer protocol handler 43 of the invention enables a server application 41s to communicate with a terminal application 41t (and vice versa) (via the tools for communication) using either SIP or HTTP.

As shown in FIG. 4B, for terminal-terminal communications according to the invention, terminal applications 41t communicate with each other (not using a browser) via a terminal protocol stack 40t-t that for terminal-terminal communications includes the application layer protocol handler 43 of the invention, the UDP/TCP/IP (routing) layer 48, and a transport layer including a first transport layer protocol stack including the HTTP (transport) layer 45 and the optional SSL (transport) layer 44 (but here not implemented as a component of a browser), and also including a second transport layer protocol stack including the SIP protocol layer 47 and the SDP protocol layer 46. As in the terminal-server communication case, there is again a (sub)layer of communication tools 42t in the application layer interfacing the application layer protocol handler 43 of the invention with the terminal application 41t. Thus, the application layer protocol handler 43 of the invention enables a terminal application 41t to communicate with another terminal application 41t via either SIP or HTTP.

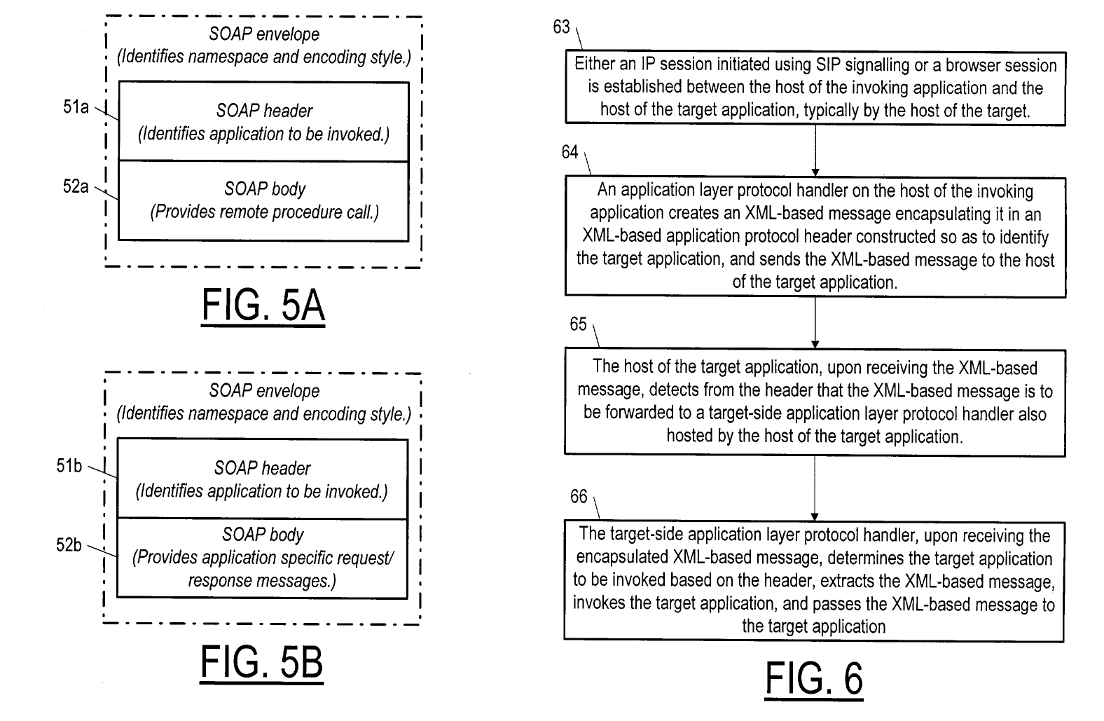

Referring now also to FIG. 5A, a SOAP message for example using a remote procedure call according to the application layer protocol handler provided by the invention is shown as including an envelope (as is required for any SOAP message), a header 51a identifying the application to be invoked on the message-receiving entity, and a body 52a providing a remote procedure call to be passed to the application to be invoked. Thus, for example, the messaging between the ticket-vendor application and the wallet application in FIG. 2 could be as follows:

From wallet application to ticket-vendor application:

```
  POST /BuyTicket HTTP/1.1
  Host: www.ticketvendorserver.com
  Content-Type: application/soap+xml; charset=“utf-8”
  Content-Length: nnnn
  <SOAP-ENV:Envelope
    xmlns:SOAP-ENV=“http://www.w3.org/2002/12/soap-envelope”>
```

<SOAP-ENV:Body>
<m:GetTicket xmlns:m=“Some-URI”>

<title>A River Runs Through It</title>

</m:GetTicket>
</SOAP-ENV:Body>

```
  </SOAP-ENV:Envelope>
From ticket-vendor application to wallet application:
  HTTP/1.1 200 OK
  Content-Type: application/soap+xml; charset=“utf-8”
  Content-Length: nnnn
  <SOAP-ENV:Envelope
    xmlns:SOAP-ENV=“http://www.w3.org/2002/12/soap-envelope”>
```

<SOAP-ENV:Body>
<m:PayPriceResponse xmlns:m=“Some-URI”>

<Price>34.5</Price>

</m:PayPriceResponse>
</SOAP-ENV:Body>

</SOAP-ENV:Envel

Note that the above is based on SOAP 1.2, and in particular the content-type of application/soap+xml is based on SOAP 1.2. More generally, the content-type is text/xml, and is as per a SOAP standard recommendation, preferably the most recent SOAP standard recommendation.

Referring now to FIG. 5B, a SOAP message for document-oriented SOAP messaging according to the application layer protocol handler provided by the invention is shown as including an envelope (as is required for any SOAP message), a header 51b identifying the application to be invoked on the message-receiving entity, and a body 52b providing the request or response messaging to be passed to the application to be invoked.

Referring now to FIG. 6, a flowchart showing the essential steps of a method of operation of a message-sending entity and a message receiving entity when invoking respective applications is shown as including a first step 63 in which iither an IP session initiated using SIP signalling or a browser session is established between the host of the invoking application and the host of the target application, typically by the host of the target. In a next step 64, an application layer protocol handler on the host of the invoking application creates an XML-based message encapsulating it in an XML-based application protocol header constructed so as to identify the target application, and sends the XML-based message to the host of the target application. In a next step 65, the host of the target application, upon receiving the XML-based message, detects from the header that the XML-based message is to be forwarded to a target-side application layer protocol handler also hosted by the host of the target application. In a next step 66, the target-side application layer protocol handler, upon receiving the encapsulated XML-based message, determines the target application to be invoked based on the header, extracts the XML-based message, invokes the target application, and passes the XML-based message to the target application.

In case the transport layer protocol is HTTP, a message is received by a terminal in response to a browser request to a server, and the message can be one part of a multi-part message so that the terminal can receive both displayable content and application-specific messages in a single response. The message has an associated type-identifier, such as e.g. the MIME-type, but other types are possible as well, such as the SDP-type. The message contains XML markup of some kind, such as e.g. and preferably, SOAP, but other markups are possible. (A SOAP message can in addition contain attachments in the case where non-XML related content—such as images or binary data—using SOAP with attachments.) The message contains an application-identifier of some kind, such as a URL, but other identifiers are also possible, such as a URN or a UUID.

Thus, the invention provides a protocol stack—one stack for to-terminal messages and another for from-terminal message—and XML-based message formats making it possible for an application hosted by a message-sending entity to invoke an application hosted by the message-receiving entity. (The protocol stack provided by the invention in combination with the prescribed XML-based message formats in combination can be viewed as an application layer protocol framework.) The stack includes an application layer protocol handler, and applications are registered with the application layer protocol handler so as to be able to receive messages from a message-sending entity based on a specific application-identifier included in the message. Messages are passed to the application layer protocol handler based on the type-identifier for the protocol (e.g. HTTP) that carries the message. Only a small number of type-identifiers are needed for this purpose such as for example, a single MIME-type. When the application layer protocol handler of the invention receives a message from one of the underlying protocols in the protocol stack, the application layer protocol handler invokes the application registered to handle the application-identifier associated with the message, and passes the received message to the invoked application. The application uses the message in some application-specific way, such as e.g. invoking a procedure indicated by a RPC (remote procedure call) in the message, the RPC being made using SOAP parameters.

The invention thus describes a general mechanism that can use existing protocols (such as HTTP and SIP) to send messages to and from applications hosted by terminals. The arriving application messages are dispatched to the correct application via a mechanism that makes it simple to create and register new applications. Applications are able to exchange any kind of message content, and in the HTTP case, a message can contain both content to be displayed in the browser and application-specific content, i.e. application message content can be received “in-band” in the HTTP response rather than “out-of-band,” such as via SMS.

The invention provides solutions for at least two problems present in existing technologies for application messaging and dispatching on mobile devices. First, as already mentioned, invoking an application on a terminal according to the prior art is based on mime-types or message formats, which depend on a central authority for uniqueness. This makes it hard to create new types; application identifiers according to the invention (such as URLs) can be generated uniquely without the need for a central authority (beyond the root namespace authority). Second, for some protocols (such as HTTP), application messaging to the terminal might not be supported either by the implementation (which may be client-only) or by the network; the use by the invention of HTTP replies to carry application messages ensures that application messaging to the terminal is supported both by the implementation (which may be client-only) and by the network.

In general, the invention uses mechanisms that are similar to those used by existing message dispatching systems in terminals (such as WAP Push). However, there are a several novel mechanisms provided by the invention in addition to providing an overall application layer protocol framework (protocol stack and conventions for messaging so as to identify an application and invoke a particular function/procedure, passing the function/procedure values for any required input parameters). First, the use according to the invention of HTTP replies to carry messages invoking an application. Second, URL-based invoking of an application on a client device (terminal), as opposed to a server.

Standardizing the protocol provided by the invention would enable interoperability between terminals of different terminal manufacturers. The application layer protocol framework provided by the invention can be used advantageously in many different terminals, and especially as a part of all series 60 and/or Symbian terminals, and more particularly, as part of MIDP (Mobile Information Device Profile) API services (offered to Java Aplets), and as part of the basic services for Symbian native applications. MIDP, combined with the Connected Limited Device Configuration (CLDC), is the Java™ runtime environment for current mobile information devices (MIDs), such as (cell) phones and entry level PDAs (personal digital assistants). What MIDP provides is the core application functionality required by mobile applications—including the user interface, network connectivity, local data storage, and application lifecycle management—packaged as a standardized Java runtime environment and set of Java APIs.

It is to be understood also that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method by which an invoking application hosted by a Web server connected to the Internet or hosted by a wireless terminal invokes a target application hosted by a wireless terminal, the method for use after either an IP session initiated using SIP signalling or a browser session is established between the host of the invoking application and the host of the target application, the method comprising:
a step (64) in which an application layer protocol handler on the host of the invoking application creates an XML-based message encapsulating it in an XML-based application protocol header constructed so as to identify the target application, and sends the XML-based message to the host of the target application;
a step (65) in which the host of the target application, upon receiving the XML-based message, detects from the header that the XML-based message is to be forwarded to a target-side application layer protocol handler also hosted by the host of the target application; and
a step (66) in which the target-side application layer protocol handler, upon receiving the encapsulated XML-based message, determines the target application to be invoked based on the header, extracts the XML-based message, invokes the target application, and passes the XML-based message to the target application.

2. A method as in 1, wherein in case of an IP session initiated using SIP signalling, an SIP client on the host of the target application, upon receiving the XML-based message provided as part of a SIP header-bearing SIP message, detects from a SDP identifier included in the SIP header that the XML-based message is to be forwarded to the target-side application layer protocol handler also hosted by the host of the target application and the application layer protocol handler in turn determines the target application based on a globally agreed-on identifier.

3. A method as in claim 2, wherein the globally agreed-on identifier is included in the XML-based application protocol header and is a URL or a URN or a UUID.

4. A method as in claim 2, wherein the XML-based application protocol header is a SOAP header.

5. A method as in 1, wherein in case of a browser session between the host of the target application and the host of the invoking application, the XML-based message is a SOAP message having a SOAP header and embedded as a MIME enclosure of a predetermined type in an XHTML or WML message, and the type of the MIME enclosure indicates that the MIME enclosure is to be provided to the target-side application layer protocol handler, and the SOAP message header identifies the target application.

6. A method as in 5, wherein the SOAP message also has a SOAP body, and the SOAP message body provides a remote procedure call for the target application.

7. A method as in 5, wherein to indicate the target application, a URL or a URN or a UUID is used.

8. A method as in 1, wherein the XML-based message is provided to the target application based either on a remote procedure call or on a simple message exchange mechanism.

9. A method as in 1, wherein the XML-based message is accompanied by a message for display to a user by the host of the target application.

10. A method as in 1, wherein the underlying transport mechanism for the XML-based message is either SIP or HTTP.

11. A terminal comprising means for performing the steps recited in claim 1 in respect to the host of the target application and also in respect to the host of the invoking application.

12. A server comprising means for performing the steps recited in claim 1 in respect to the host of the invoking application in case the host of the invoking application is the Web server connected to the Internet.

13. A system, comprising a terminal and a server, the terminal and the server comprising means for performing the steps of claim 1 in respect to the host of the target application and the host of the invoking application, respectively.

14. An apparatus implementing a protocol stack (40s 40t-s 40t-t) by which an application hosted by a wireless terminal communicates with an application on a second device that is either a Web server connected to the Internet or another wireless terminal, the protocol stack (40s 40t-s 40t-t) comprising:
a routing layer (48), for providing connectivity between the terminal and the second entity;
a transport layer, interfacing with the routing layer (48) for providing transport services and including at least one transport layer protocol stack including a HTTP transport layer (45);
an application layer protocol handler (43), interfacing with the transport layer and also interfacing with an application (41s 41t) via communication tools (42s 42t) so as to provide communication services to and from the application (41s 41t);
at least one application;
wherein in response to an XML-based message encapsulated in an XML-based application protocol header constructed so as to identify the at least one application, the application protocol layer handler (43) invokes the at least one application according to the XML-based message.

15. An apparatus as in claim 14, wherein the protocol stack further comprises: in the transport layer, a second transport layer protocol stack including a SIP transport layer (47) and a SDP transport layer (48).

16. A method by which an invoking application hosted by a Web server connected to the Internet or hosted by a wireless terminal invokes a target application hosted by a wireless terminal, the method comprising:
a step (63) in which either the host of the invoking application or the host of the target application initiates with the other an IP session using SIP signalling;
a step (64) in which an application layer protocol handler on the host of the invoking application creates an XML-based message encapsulating it in an XML-based application protocol header identifying the target application and sends the XML-based message to the host of the target application using a transport protocol suitable for communication via the IP session;
a step (65) in which an SIP client on the host of the target application, upon receiving the XML-based message, detects from a globally agreed-on identifier included in the header that the XML-based message is to be forwarded to a target-side application layer protocol handler also hosted by the host of the target application; and
a step (66) in which the target-side application layer protocol handler, upon receiving the encapsulated XML-based message, determines the target application to be invoked, extracts the XML-based message, invokes the target application, and passes the XML-based message to the target application.

17. A method as in 16, wherein the header is a SOAP header.

18. A method as in 16, wherein the globally agreed-on identifier is a SIP SDP identifier or a MIME identifier.

19. A method by which an invoking application hosted by a Web server connected to the Internet or hosted by a wireless terminal invokes a target application hosted by a wireless terminal, the method comprising:
a step (63) in which a browser on the host of the target application initiates a browser session with the host of the invoking application;
a step (64) in which an application layer protocol handler on the host of the invoking application creates an XML-based message encapsulating it in an XML-based application protocol header having a predetermined MIME format and sends the XML-based message to the host of the target application via the browser session;
a step (65) in which the host of the target application, upon receiving the XML-based message, determines from the MIME format of the header that the message is to be forwarded to a target-side application layer protocol handler also hosted by the host of the target application, and provides the message to the target-side application layer protocol handler; and
a step (66) in which the target-side application layer protocol handler, upon receiving the encapsulated XML-based message, determines the target application to be invoked based on the header, extracts the XML-based message, invokes the target application, and passes the XML-based message to the target application.

20. A method as in 19, wherein the header is according to SOAP.

21. A computer program product comprising: a computer readable storage structure embodying computer program code thereon for execution by a computer processor in a terminal hosting a target application (21) and used for communicating with a Web server (22) connected to the Internet or another terminal (21) hosting an invoking application, said computer program code for use after either an IP session initiated using SIP signalling or a browser session is established between the host of the invoking application and the host of the target application and after an application layer protocol handler on the host of the invoking application creates an XML-based message encapsulating it in an XML-based application protocol header constructed so as to identify the target application, and sends the XML-based message to the host of the target application, said computer program code comprising:
computer program code for causing the computer processor to perform a step (65) in which the host of the target application, upon receiving the XML-based message, detects from the header that the XML-based message is to be forwarded to a target-side application layer protocol handler also hosted by the host of the target application; and
computer program code for causing the computer processor to perform a step (66) in which the target-side application layer protocol handler, upon receiving the encapsulated XML-based message, determines the target application to be invoked based on the header, extracts the XML-based message, invokes the target application, and passes the XML-based message to the target application.

22. A computer program product comprising: a computer readable storage structure embodying computer program code thereon for execution by a computer processor in a Web server (22) connected to the Internet or terminal (21) hosting an invoking application and communicating with a terminal hosting a target application (21), said computer program code for use after either an IP session initiated using SIP signalling or a browser session is established between the host of the invoking application and the host of the target application, said computer program code comprising:
computer program code for causing the computer processor to perform a step (64) in which an application layer protocol handler on the host of the invoking application creates an XML-based message encapsulating it in an XML-based application protocol header constructed so as to identify the target application; and
computer program code for causing the computer processor to perform a step (64) of sending the XML-based message to the host of the target application;
wherein the XML-based message and its encapsulation are such as to make possible detection by the host of the target application that the XML-based message is intended for delivery to the target application.
